(19) United States
(12) Patent Application Publication
(10) Pub. No.: US 2002/0105395 A1
(43) Pub. Date: Aug. 8, 2002

(54) DC block circuit and communication equipment

(76) Inventor: Minoru Tajima, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/073,220

(22) Filed: Feb. 13, 2002

(30) Foreign Application Priority Data
Dec. 14, 2000 (JP) 2001-382033

(51) Int. Cl. H01P 1/00

(52) U.S. Cl. 333/245; 333/247

(57) ABSTRACT

A DC block circuit comprises a conductive line (3) disposed on one surface of a dielectric substrate (1), via which an electrical signal is passed, an interdigital capacitor (6) forming a part of the conductive line (3), and a chip capacitor (4) that is disposed so that the interdigital capacitor (6) is sandwiched between the chip capacitor (4) and the dielectric substrate (1), and that is connected to the conductive line (3) so that the chip capacitor (4) is in parallel with the interdigital capacitor (6).

### BACKGROUND OF THE INVENTION

1. Field of the Invention

The present invention relates to a DC block circuit that connects two electric circuits having different bias supply voltages to each other, and that prevents interference of one bias supply voltage from one of the two electric circuits to the other electric circuit, and also relates to communication equipment which employs the DC block circuit.

2. Description of the Prior Art

In general, each of a multiplexing circuit, a demultiplexing circuit, a driver, and a preamplifier which are used in communication equipment, such as an optical transmitter and receiver, is integrated into one chip. These IC circuits might be manufactured in different processes. For example, in the case of manufacturing a 40 Gbit/s light transmitter/receiver, such a high-density IC as a multiplexing IC or a demultiplexing IC may be manufactured in a SiGe process having an advantage in power consumption and yields in most cases, whereas such an IC giving a priority to speedups as a driver IC or a preamplifier IC may be manufactured in an InP or GaAs process in most cases.

Usually, these IC circuits have different bias supply voltages. To avoid interference between the different bias supply voltages in connection between the IC circuits, there is a necessity to dispose a DC block circuit for blocking DC components between the IC circuits. The DC block circuit should block DC components and pass high-frequency signals having a predetermined transmission bit rate with a low transmission loss.

FIGS. 8A to 8C are diagrams showing the structure of a prior art DC block circuit, and FIGS. 8A and 8B are top plan views of the DC block circuit and FIG. 8C is a side view of the DC block circuit. In FIGS. 8A to 8C, reference numeral 101 denotes a dielectric substrate, reference numeral 102 denotes a ground conductor disposed on one surface of the dielectric substrate 101, and reference numeral 103 denotes a conductive line disposed on another surface of the dielectric substrate 101. The DC block circuit of FIGS. 8A to 8C constitutes a microstripline. Reference numeral 104 denotes a chip capacitor mounted on the conductive line 103. FIG. 8C shows the DC block circuit from which the chip capacitor 104 is removed when viewed from an upper surface thereof, and a gap 105 is formed as shown in FIG. 8C.

As shown in FIGS. 8A to 8C, the gap 105 is disposed in the conductive line 103 and the chip capacitor 104 is mounted on this gap 105 with solder or the like, so that the DC block circuit is simply constructed. In order to pass signals in a low-frequency band with a low transmission loss, the chip capacitor preferably has a large capacitance, e.g., about 0.1 μF within the bounds of not hindering the mounting of the chip capacitor 104 onto the conductive line 103.

If the chip capacitor 104 has only a pure capacitance component, the impedance of the chip capacitor 104 becomes smaller and hence the transmission loss of a high-frequency signal applied to the chip capacitor becomes smaller with increasing frequency of the signal. However, the chip capacitor 104 surely has an inductive component in series to the capacitance component in reality. Therefore, in the DC block circuit of FIGS. 8A to 8C, an impedance of the chip capacitor 104 resulting from the inductive component increases and hence the transmission loss increases in a frequency band which exceeds the self resonant frequency of the chip capacitor 104 with increasing frequency of the high-frequency signal applied to the chip capacitor.

The DC block circuit of FIGS. 8A to 8C can still provide a practicable transmission loss if the high-frequency signal applied to the DC block circuit has a transmission bit rate of up to about 2.5 Gbit/s or 10 Gbit/s. On the other hand, when the high-frequency signal applied to the DC block circuit has a transmission bit rate of up to 40Gbit/s, a transmission circuit with a low transmission loss in a frequency band of about 4 MHz to 60 GHz is required. However, the DC block circuit of FIGS. 8A to 8C cannot provide a sufficiently-reduced transmission loss.

Furthermore, in general, there is a tendency that the transmission loss of a high-frequency signal applied to a capacitor increases with increasing capacitance of the capacitor. However, there causes a problem: reducing the capacitance of the capacitor to reduce the transmission loss of a high-frequency signal increases the transmission loss of a low-frequency signal.

As a solution of this problem, there can be provided a method of arranging a large-capacitance capacitor that passes low-frequency signals with a low transmission loss and a small-capacitance capacitor that passes high-frequency signals with a low transmission loss in parallel with each other on the conductive line.

FIGS. 9A and 9B are diagrams showing variations of another prior art DC block circuit in which a large-capacitance capacitor and a small-capacitance capacitor are connected in parallel with each other. Both the figures are top plan views. In the figure, the same reference numerals as shown in FIGS. 8A to 8C denote the same components as those of the above-mentioned prior art DC block circuit or like components. In FIGS. 9A and 9B, reference numeral 106 denotes an interdigital capacitor forming a part of a conductive line 103.

In FIG. 9A, the interdigital capacitor 106 is branched from the conductive line 103 and is formed on a dielectric substrate 101. On the other hand, in FIG. 9B, the interdigital capacitor 106 is formed in a segment of the conductive line which corresponds to the gap 105 of FIG. 8C, and the chip capacitor 104 is branched from the conductive line 103 and is formed on a dielectric substrate 101. Thus, in either case of FIGS. 9A and FIG. 9B, the interdigital capacitor 106 is arranged in parallel with the chip capacitor 104.

Compared with the chip capacitor 104, the interdigital capacitor 106 is more suitable for passing high-frequency signals because the interdigital capacitor 106 generally has a small capacitance but has a sufficiently small inductive component. In other words, the DC block circuit shown in either of FIGS. 9A and 9B can work on a wider frequency band compared with the DC block circuit shown in FIGS. 8A to 8C which employs the chip capacitor 104 only.

However, in these DC block circuits, the characteristic impedance fluctuates at the branch point in the conductive line 103 because the chip capacitor 104 and the interdigital capacitor 106 are arranged on the dielectric substrate 101 so that they are branched from each other, as shown in FIGS. 9A and 9B. It is therefore necessary to sufficiently reduce the width of a branched line 107 as shown in FIG. 9A to reduce the fluctuation in the characteristic impedance at the branch point. However, as a result, the reflection of a high-frequency signal increases in the case of FIG. 9A (the transmission loss also increases), and, on the other hand, the reflection of a low-frequency signal increases in the case of FIG. 9B (the transmission loss also increases).

Although it is possible to achieve the match of the characteristic impedance of the conductive line at the branch point by adjusting the width of the branched line and to provide a balance between the transmission loss of high-frequency signals and that of low-frequency signals, it is difficult to reduce the transmission loss of high-frequency signals and that of low-frequency signals both after all because it is impossible to separate frequency components from one another at the branch point. Furthermore, a waveform degradation can occur in high-frequency signals because the reflection generated in the chip capacitor becomes an interference wave flowing into the other branched line. In addition, another problem is that since the distribution of a magnetic field H (its time factor is neglected and only in-phase components are shown in the figure) fluctuates because of the branched lines, as shown in FIGS. 9A and 9B, the conductive line can easily emit unnecessary radiation and this results in causing electromagnetic interference with electrical instruments.

As previously mentioned, a problem with a prior art DC block circuit constructed as mentioned above is that it cannot provide an excellent reflection property and a good transmission loss characteristic over a wide frequency band.

Another problem is that prior art communication equipment provided with a plurality of electric circuits having different bias supply voltages which are connected to one another by way of prior art DC block circuits cannot support high transmission bit rates.

### SUMMARY OF THE INVENTION

The present invention is proposed to solve the above-mentioned problems, and it is therefore an object of the present invention to provide a DC block circuit that can provide both an excellent reflection property and a good transmission loss characteristic over a wide frequency band

It is another object of the present invention to provide communication equipment that can support high transmission bit rates even if it is provided with a plurality of electric circuits having different bias supply voltages.

In accordance with an aspect of the present invention, there is provided a DC block circuit comprising: a conductive line disposed on one surface of a dielectric substrate; an interdigital capacitor forming a part of the conductive line; and a chip capacitor that is disposed so that the interdigital capacitor is sandwiched between the chip capacitor and the dielectric substrate. Accordingly, the aspect offers an advantage of being able to provide an excellent reflection property and a good transmission loss characteristic over a wide frequency band.

In accordance with another aspect of the present invention, there is provided communication equipment comprising: a DC block circuit including a conductive line disposed on one surface of a dielectric substrate, an interdigital capacitor forming a part of the conductive line, and a chip capacitor that is disposed so that the interdigital capacitor is sandwiched between the chip capacitor and the dielectric substrate; a first electric circuit connected to an end of the DC block circuit; and a second electric circuit connected to another end of the DC block circuit, the second electric circuit having a bias supply voltage different from that of the first electric circuit. Accordingly, the other aspect offers an advantage of being able to support high transmission bit rates even if the communication equipment is provided with the plurality of electric circuits having different bias supply voltages.

In accordance with a further aspect of the present invention, the DC block circuit further includes connectors on bot ends of the conductive line.

In accordance with another aspect of the present invention, the interdigital capacitor, and the chip capacitor have substantially equal widths.

In accordance with a further aspect of the present invention, the chip capacitor has a width greater than that of the conductive line.

In accordance with an other aspect of the present invention, the interdigital capacitor has a width greater than that of the conductive line.

In accordance with a further aspect of the present invention, the interdigital capacitor is coated with a resist film constructed of an insulator.

In accordance with another aspect of the present invention, a microstripline including a ground conductor formed on another surface of the dielectric substrate is constructed.

In accordance with a further aspect of the present invention, a coplanar line including a ground conductor formed on the surface of the dielectric substrate is constructed.

In accordance with another aspect of the present invention, a grounded coplanar line including two ground conductors respectively formed on the surface and another surface of the dielectric substrate is constructed.

In accordance with a further aspect of the present invention, the communication equipment comprises a multiplexing circuit, as the first electric circuit, that outputs an electrical signal to the DC block circuit, and an EA modulator, as the second electric circuit, that generates an intensity-modulated optical signal from a continuous wave optical signal according to the electrical signal applied there to by way of the DC block circuit.

In accordance with another aspect of the present invention, the communication equipment comprises a photo diode with a preamplifier, as the first electric circuit, for converting an intensity-modulated optical signal applied thereto into an amplitude-modulated electrical signal, and a demultiplexer, as the second electric circuit, for demultiplexing the amplitude-modulated electrical signal.

Further objects and advantages of the present invention will be apparent from the following description of the preferred embodiments of the invention as illustrated in the accompanying drawings.

### BRIEF DESCRIPTION OF THE DRAWINGS

FIGS. 1A to 1C are diagrams showing the structure of a DC block circuit according to a first embodiment of the present invention;

FIG. 2 is a diagram showing an outline view of an interdigital capacitor of the DC block circuit according to the first embodiment;

FIG. 3 is a diagram showing an example of the structure of communication equipment according to the first embodiment of the present invention;

FIGS. 4A to 4C are diagrams showing the structure of a DC block circuit according to a second embodiment of the present invention;

FIGS. 5A to 5C are diagrams showing the structure of a DC block circuit according to a third embodiment of the present invention;

FIGS. 6A to 6C are diagrams showing the structure of a DC block circuit according to a fourth embodiment of the present invention;

FIGS. 7A to 7C are diagrams showing the structure of a DC block circuit according to a fifth embodiment of the present invention;

FIGS. 8A to 8C are diagrams showing the structure of a prior art DC block circuit; and

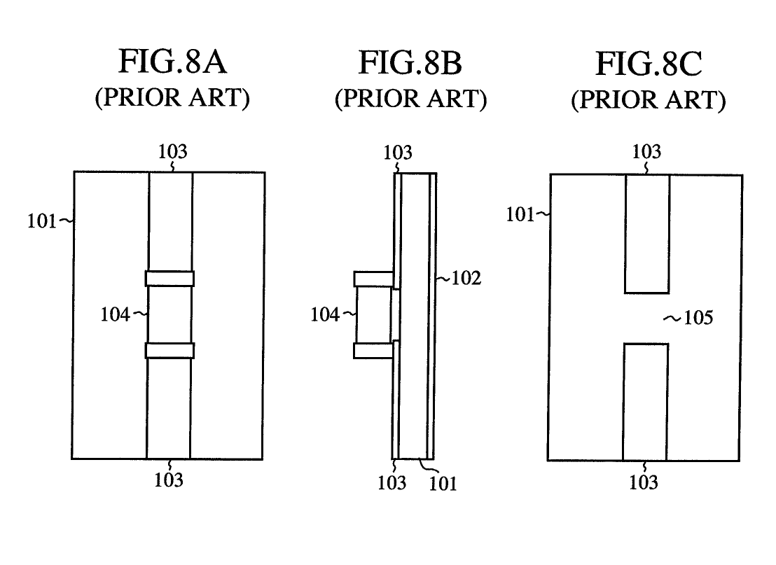

FIGS. 9A and 9B are diagrams showing the structure of another prior art DC block circuit in which a large-capacitance capacitor and a small-capacitance capacitor are arranged in parallel with each other.

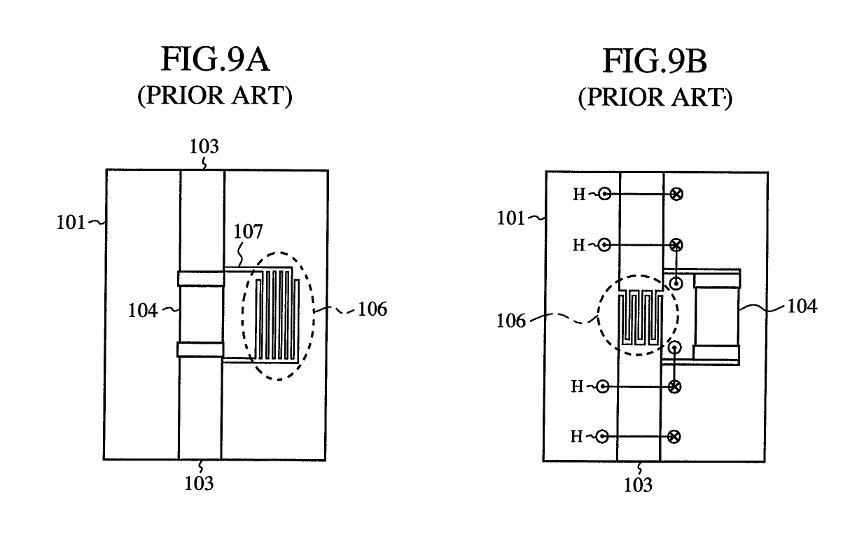

### DETAILED DESCRIPTION OF THE PREFERRED EMBODIMENTS

Embodiment 1.

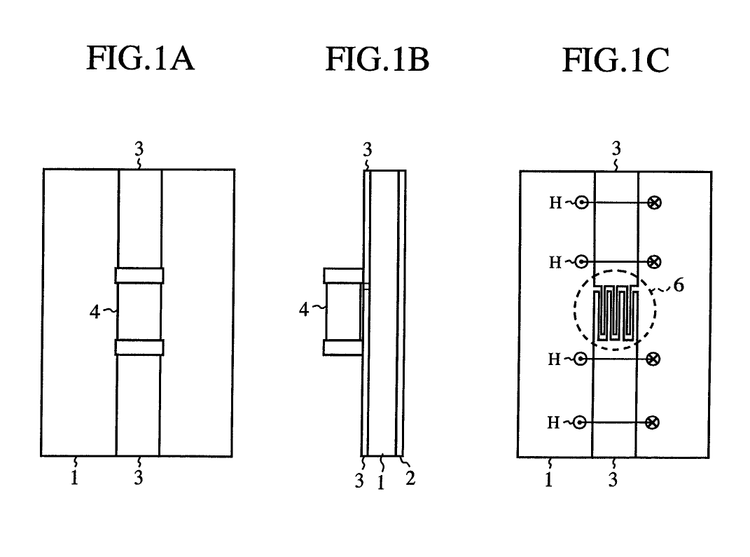

FIGS. 1A to 1C are diagrams showing the structure of a DC block circuit according to a first embodiment of the present invention, and FIGS. 1A and 1C are top plan views of the DC block circuit and FIG. 1B is a side view of the DC block circuit. In FIGS. 1A to 1C, reference numeral 1 denotes a dielectric substrate, reference numeral 2 denotes a ground conductor disposed on one surface of the dielectric substrate 1, and reference numeral 3 denotes a conductive line disposed on another surface of the dielectric substrate 1. The DC block circuit of FIGS. 1A to 1C constitutes a microstripline. In addition, reference numeral 4 denotes a chip capacitor mounted on the conductive line 3, and reference numeral 6 denotes an interdigital capacitor. FIG. 1C shows the DC block circuit from which the chip capacitor 4 is removed when viewed from an upper side thereof. The chip capacitor 4 is so disposed that the interdigital capacitor 6 is sandwiched between the chip capacitor 4 and the dielectric substrate 1.

Since the chip capacitor 4 is mounted just above the interdigital capacitor 6 forming a part of the conductive line 3 so that the chip capacitor 4 is in parallel with the interdigital capacitor 6 and therefore no branched line is needed, as shown in FIGS. 1A to 1C, fluctuations in the characteristic impedance on the conductive line can be reduced and the DC block circuit can allow both high-frequency signals and low-frequency signals to pass therethrough with low reflection and low transmission losses. Especially, since fluctuations in the distribution of a magnetic field H (its time factor is neglected and only in-phase components are shown in the figure), i.e., an electromagnetic-field distribution, can be reduced, as shown in FIG. 1C, by making the width of the conductive line 3, the width of the interdigital capacitor 6, and the width of the chip capacitor 4 approximately equal to one another, the generation of reflected waves and unnecessary radiation can be suppressed to a minimum.

Compared with a prior art DC block circuit, there causes a limit to a capacitance provided by the interdigital capacitor 6. The feasibility of the interdigital capacitor 6 will be evaluated as follows.

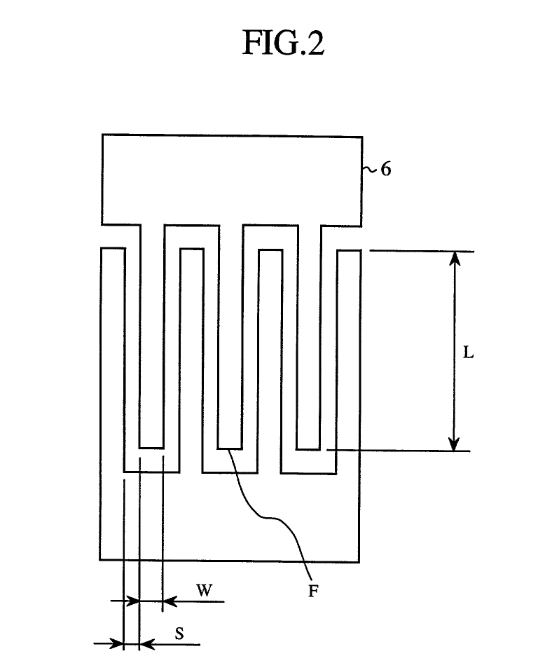

FIG. 2 is a diagram showing an outline view of the interdigital capacitor 6. The capacitance C of the interdigital capacitor 6 having electrodes (fingers) F is given by the following equation (1).

C32 (n−1)C₀L (1)

where the following equations (2) to (4) are also satisfied.

$$\begin{matrix}{C}_{0} = {ϵ}_{0} ( 1 + {ϵ}_{r} ) \frac{K ( k )}{K ( {k}^{′} )} & ( 2 ) \\ k = {tan}^{2} ( \frac{π}{4} \frac{W}{W + S} ) & ( 3 ) \\ {k}^{′} = \sqrt{1 - {k}^{2}} & ( 4 )\end{matrix}$$

k′−\sqrt{1−k²} (4)

where it is assumed that the thickness of each electrode F is 0, and where n is the number of electrodes F, L is the length of each electrode F, W is the width of each electrode F, S is a spacing between electrodes F, ε0 is an electric constant of vacuum ( [symbol] 8. 854×10⁻¹² F/m), ε0 is a specific inductive capacity of the dielectric substrate 1, and K(k) is a complete elliptic integral. Furthermore, the following approximate expression having an error of 3% or less can be established in the equation (1).

$$\frac{K ( k )}{K ( {k}^{′} )} = \{ \begin{matrix}π / ln ( 2 \frac{1 + \sqrt{{k}^{′}}}{1 - \sqrt{{k}^{′}}} ) & 0 \leq {k}^{2} \leq 0.5 \\ \frac{1}{π} ln ( 2 \frac{1 + \sqrt{k}}{1 - \sqrt{k}} ) & 0.5 \leq {k}^{2} \leq 1.\end{matrix} \qquad ( 5 )$$

Next, a calculation example of the capacitance will be shown when the interdigital capacitor 6 is formed on the conductive line 3 whose characteristic impedance is 50 Ω on an alumina substrate having a thickness of 0.5 mm (it is assumed that εr=9). The width of the conductive line 3 whose characteristic impedance is 50 Ω is nearly 0.5 mm, and n=26 when assuming that L=1 mm and W=S=0.01 mm. When substituting these values into the equations (1) to (5), the capacitance C is determined as C [symbol] 1.1 pF.

Since the interdigital capacitor 6 has a small resistance resulting from the capacitance (for example, 3 Ω at 40 GHz, or 2 Ω at 60 GHz), it is apparent that in a transmission circuit for use with a high-speed optical transmitter and receiver having a transmission bit rate, such as 40 Gbit/s, the concurrent use of the interdigital capacitor is useful because the transmission loss of high-frequency components can be reduced.

Since although it is assumed that the thickness of each electrode F is 0 in this calculation example, each electrode actually has a certain thickness and the interdigital capacitor therefore has a larger capacitance than the calculated value, it can be determined that the resistance to the flow of high-frequency components is further decreased. Furthermore, when the chip capacitor mounted on the interdigital capacitor has a width that is substantially equal to that of the conductive line, it is also possible to reduce the reflection coefficient over a wide frequency band.

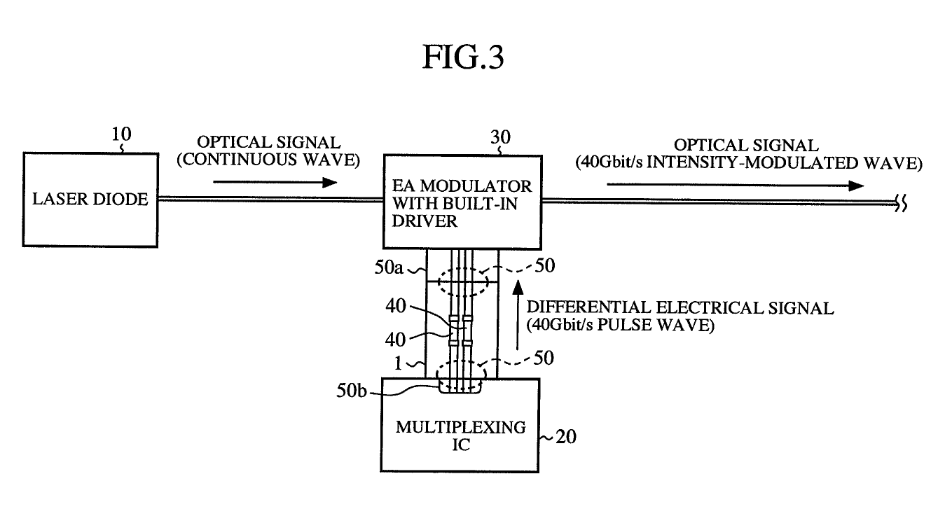

Next, an example of the structure of communication equipment which employs the DC block circuit according to the first embodiment will be explained. FIG. 3 is a diagram showing the structure of the communication equipment according to the first embodiment of the present invention, and the communication equipment shown in FIG. 3 is a 40 Gbit/s light transmitter which employs the DC block circuit of FIGS. 1A to 1C.

In FIG. 3, reference numeral 10 denotes a laser diode (LD) that outputs an optical signal which is a continuous wave, and reference numeral 20 denotes a multiplexing IC package that outputs a differential electrical signal which is a 40 Gbit/s pulse wave, for example. A multiplexing IC (first electric circuit) not shown in the figure is included in this multiplexing IC package 20. Reference numeral 30 denotes a EA modulator having a built-in driver, for modulating the optical signal from the LD 10 into an intensity-modulated optical signal such as a 40 Gbit/s optical signal. A driver (second electric circuit) not shown in the figure is included in this EA modulator 30. Reference numeral 40 denotes a DC block circuit shown in FIG. 1, and reference numeral 50 denotes a joint, such as a wire or ribbon, for connecting the EA modulator 30 with the built-in driver and the multiplexing IC package 20 to two DC block circuits 40. The EA modulator 30 with the built-in driver has a feed through 50a for electrically connecting the driver built in the EA modulator 30 to an electric component disposed outside the EA modulator. Similarly, the multiplexing IC package 20 has a feed through 50b for electrically connecting the multiplexing IC built in the multiplexing IC package 20 to an electric component disposed outside the multiplexing IC package. The dielectric substrate 1 on which the two DC block circuits 40 are formed is connected to the feedthroughs 50a and 50b (i.e., the joints 50) at both ends thereof. As a result, the multiplexing IC and the driver are connected to each other by way of the two DC block circuits 40. As can be seen from FIG. 3, it is assumed that the communication equipment of the first embodiment includes a differential line provided with a ground conductor 2 formed on a bottom surface of the dielectric substrate 1 on which the two DC block circuits 40 are formed, and both an interdigital capacitor 6 and a chip capacitor 4 are disposed on each of the two signal lines formed between the multiplexing IC package 20 and the EA modulator 30 with the built-in driver.

In operation, an optical signal output from the LD 10 is input to the EA modulator 30 with the built-in driver. On the other hand, the multiplexing IC package 20 outputs a high-speed differential electrical signal and then furnishes the differential electrical signal to the EA modulator 30 with the built-in driver by way of the two DC block circuits 40 so as to drive the EA modulator 30 with the built-in driver. The EA modulator 30 with the built-in driver modulates the optical signal from the LD 10 according to the differential electrical signal applied thereto, and outputs the modulated optical signal as a high-speed intensity-modulated optical signal.

Since the driver built in the EA modulator 30 is manufactured in an InP or GaAs process and the multiplexing IC built in the multiplexing IC package 20 is manufactured in a SiGe process, for example, there causes a difference between the bias supply voltages of those circuits because of the difference between those processes. In order to prevent the different bias supply voltages from flowing from their sources into the other circuits, respectively, the two DC block circuits 40 are disposed between the EA modulator 30 with the built-in driver and the multiplexing IC package 20, so that the flow of DC components can be prevented. The differential electrical signal from the multiplexing IC package 20 is furnished to the EA modulator 30 with the built-in driver by way of the two DC block circuits 40. Since each DC block circuit 40 according to the first embodiment provides an excellent reflection property and a good transmission loss characteristic over a wide range from a low frequency to a high frequency, as mentioned above, the communication equipment of the first embodiment can sufficiently support differential electrical signals having a high transmission bit rate, such as 40 Gbit/s, and hence a wide frequency band.

In the communication equipment of FIG. 3, the EA modulator 30 with the built-in driver and the multiplexing IC package 20 are connected to each other by way of the two DC block circuits 40 which are electrically connected to both the feedthroughs 50a and 50b at the joint 50. The communication equipment of the present invention is not limited to the one having the structure shown. Also, the DC block circuit of the present invention is not limited to the one having the structure shown. For example, it is possible to mount a connector intended for high frequencies, such as an SMA (registered trademark) connector which can support up to about 20 GHz, a K (registered trademark) connector which can support up to about 40GHz, or a V (registered trademark) connector which can support up to about 65 GHz, at each of the input and both output ends of part of the conductive line 3 which constitutes each DC block circuit 40. When such a high-frequency connector is mounted at each end of each DC block circuits 40, a first electric circuit having the same high-frequency connector mounted therein and a second electric circuit having the same high-frequency connector mounted therein can be easily connected to each other by way of the two DC block circuits 40. In other words, the general versatility of each DC block circuit 40 can be improved.

In the example shown in FIG. 3, the multiplexing IC disposed within the multiplexing IC package 20 is used as the first electric circuit, and the driver disposed within the EA modulator 30 is used as the second electric circuit. However, the first and second electric circuits connected to each other by way of the two DC block circuits 40 are not limited to the ones shown in FIG. 3. For example, the first and second electric circuits can simply be such two electric circuits having different bias supply voltages as a photodiode (PD) with a built-in preamplifier, for converting a high-speed intensity-modulated optical signal applied thereto into a high-speed amplitude-modulated electrical signal, and a demultiplexer (DMUX) for demultiplexing the amplitude-modulated electrical signal, which are connected to each other by way of the two DC block circuits 40 in the communication equipment which can be a photoreceiver. Other examples (A) to (C) of communication equipment in which the first and second electric circuits are connected to each other by way of the two DC block circuits 40 will be shown.

(A) Communication equipment, disposed as an LD/PD module, in which an optical device, such as an LD or PD, and a preamplifier or driver for use with the optical device are connected to each other by way of the two DC block circuits 40.

(B) Communication equipment, disposed as an optical transmitter and receiver, in which an LD/PD module (which can be the above-mentioned module (A)) provided with an optical device, such as an LD or PD, and a preamplifier or driver for use with the optical device, and an IC circuit, such as a multiplexer (MUX) or a DMUX, are connected to each other by way of the two DC block circuits 40.

(C) Communication equipment, disposed as an optical transmitter and receiver, in which two LD/PD modules (each of which can be the above-mentioned module (A)) provided with an optical device, such as an LD or PD, and a preamplifier or driver for use with the optical device, are connected to each other by way of the two DC block circuits 40.

As an alternative, the communication equipment of the first embodiment can employ two DC block circuits each of which has a structure according to any one of the second through fifth embodiments described later, instead of the two DC block circuits 40 each having a structure shown in FIG. 1 of the first embodiment.

As mentioned above, in accordance with the first embodiment, the DC block circuit comprises a conductive line 3 disposed on one surface of a dielectric substrate 1, via which an electrical signal is passed, an interdigital capacitor 6 forming a part of the conductive line 3, and a chip capacitor 4 that is disposed so that the interdigital capacitor 6 is sandwiched between the chip capacitor 4 and the dielectric substrate 1, and that is connected to the conductive line 3 so that the chip capacitor is in parallel with the interdigital capacitor 6. Accordingly, the first embodiment offers an advantage of being able to provide an excellent reflection property and a good transmission loss characteristic over a wide frequency band.

Furthermore, in accordance with the first embodiment, since the conductive line 3 is provided with a connector intended for high frequencies via which an electrical signal is input and output at each of input and output ends thereof, the general versatility of the DC block circuit can be improved.

In addition, in accordance with the first embodiment, a ground conductor 2 is disposed on another surface of the dielectric substrate 1 so that a microstripline is constructed. Accordingly, the first embodiment offers an advantage of being able to provide an excellent reflection property and a good transmission loss characteristic over a wide frequency band.

In addition, in according with the first embodiment, the conductive line 3, the interdigital capacitor 6, and the chip capacitor 4 have substantially equal widths. Accordingly, the first embodiment offers advantages of being able to reduce fluctuations in the characteristic impedance of the conductive line and being able to provide an excellent reflection property and a good transmission loss characteristic over a wide frequency band.

In addition, in according with the first embodiment, the communication equipment comprises two DC block circuits 40, a first electric circuit having a first bias supply voltage, and a second electric circuit having a second bias supply voltage different from the first bias supply voltage, the second electric circuit being electrically connected to the first electric circuit by way of the two DC block circuits 40. Accordingly, the communication equipment can support high transmission bit rates.

In addition, in accordance with the first embodiment, the communication equipment is provided with a multiplexing IC, as the first electric circuit, that outputs an electrical signal for driving a driver to the two DC block circuits 40, and the driver, as the second electric circuit, that outputs a continuous wave optical signal from an LD 10 as an intensity-modulated optical signal according to the electrical signal applied thereto by way of the two DC block circuits 40. Accordingly, the communication equipment can support high transmission bit rates.

In the first embodiment, a driver is included in the EA modulator, as previously explained. However, the present invention is not limited to the case and the driver can be disposed outside the EA modulator.

In addition, in accordance with the first embodiment, the communication equipment is provided with a photo diode with a built-in preamplifier, as the first electric circuit, for converting an intensity-modulated optical signal applied thereto into an amplitude-modulated electrical signal, and a demultiplexer, as the second electric circuit, for demultiplexing the amplitude-modulated electrical signal. Accordingly, the communication equipment can support high transmission bit rates.

Embodiment 2.

When the interdigital capacitor has a width substantially equal to that of the chip capacitor and hence an inadequate capacitance, it is possible to thin the width of each electrode of the interdigital capacitor and to increase the number of electrodes, so as to increase the capacitance of the interdigital capacitor. However, there causes a limit to the thinness of the width of each electrode because of constraints of the working of the electrodes due to etching accuracy, the risk of a short-circuit, and so on. In accordance with a second embodiment, there is provided a technique for ensuring an adequate capacitance without thinning the width of each electrode of the interdigital capacitor.

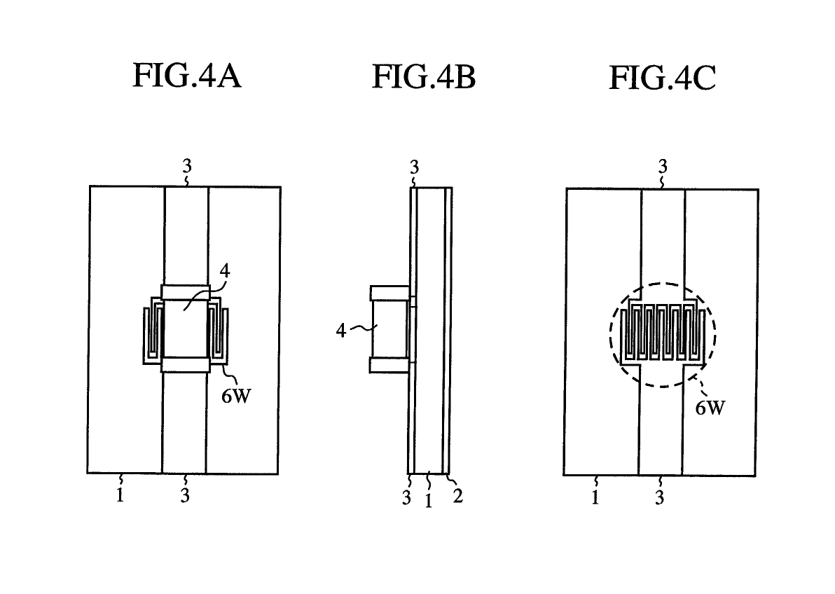

FIGS. 4A to 4C are diagrams showing the structure of a DC block circuit according to the second embodiment of the present invention, and FIGS. 4A and 4B are top plan views of the DC block circuit and FIG. 4C is a side view of the DC block circuit. The same reference numerals as shown in FIG. 1 denote the same components as those of the first embodiment or like components. In FIGS. 4A to 4C, reference numeral 6W denotes the interdigital capacitor having a width greater than that of a chip capacitor 4.

When the chip capacitor 4 is small in size, and the interdigital capacitor 6 of FIG. 1 cannot provide an adequate capacitance because it has a width approximately equal to that of the chip capacitor 4, it is effective to use the interdigital cap capacitor 6W having a width greater than that of the chip capacitor 4 for the DC block circuit, as shown in FIGS. 4A and 4C, instead of the interdigital degree 6. In this case, although the reflection property deteriorates as the width of the interdigital capacitor 6W increases, the reflection can be reduced compared with a prior art structure in which a branch is disposed in the conductive line.

Although there is no limit to how the interdigital capacitor 6W is expanded in width, when the interdigital capacitor 6W is expanded in width so that it is symmetric with respect to the conductive line 3 along which signals are transmitted, fluctuations in the electromagnetic-field distribution can be reduced and deterioration of the reflection property and the transmission loss characteristic can be reduced. Furthermore, the chip capacitor 4 can have a width greater than that of the conductive line 3, and therefore can have an adequate capacitance.

As mentioned above, in accordance with the second embodiment, the DC block circuit is provided with an interdigital capacitor 6W having a width greater than that of the chip capacitor 4. Accordingly, the reflection property can be improved as compared with a prior art DC block circuit, and the interdigital capacitor 6W can have an adequate capacitance.

Furthermore, in accordance with the second embodiment, the chip capacitor 4 can be so constructed as to have a width greater than that of the conductive line 3. Accordingly, the reflection property can be improved as compared with a prior art DC block circuit, and the chip capacitor 4 can have an adequate capacitance.

Embodiment 3.

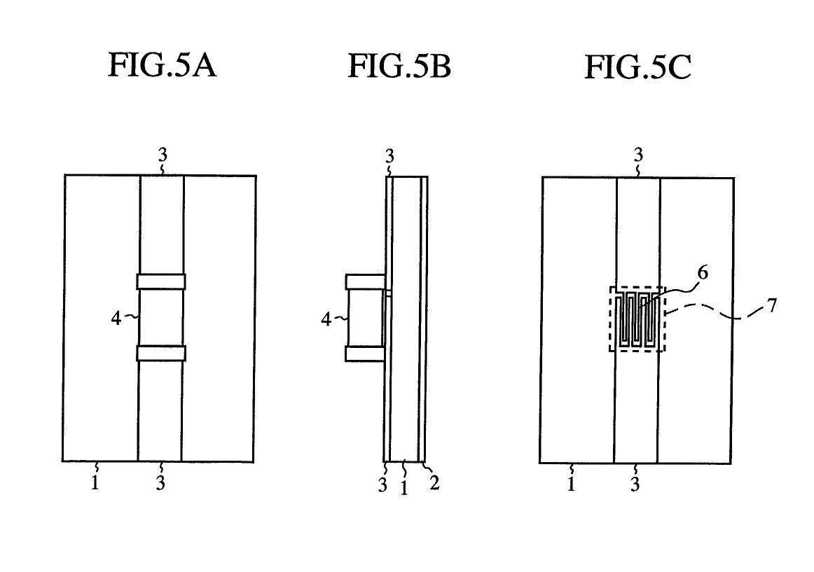

FIGS. 5A to 5C are diagrams showing the structure of a DC block circuit according to a third embodiment of the present invention, and FIGS. 5A and 5B are top plan views of the DC block circuit and FIG. 5C is a side view of the DC block circuit. The same reference numerals as shown in FIG. 1 denote the same components as those of the first embodiment or like components. In FIGS. 5A to 5C, reference numeral 7 denotes a resist film constructed of an insulator and formed on an interdigital capacitor 6.

When a chip capacitor 4 is bonded onto the interdigital capacitor 6 with solder or the like, there is a possibility that adjacent electrodes of the interdigital capacitor 6 are short-circuited because of the solder's extending and therefore DC components can be passed through the interdigital capacitor 6. As a measure against the solder's extending, the resist film 7 constructed of an insulator is formed on the interdigital capacitor 6, and the interdigital capacitor 6 is thus coated with the film, as shown in FIG. 5C. The resist film 7 can have such a thickness as not to hinder the bonding of the chip capacitor 4. Of course, the application of the third embodiment is not limited to the interdigital capacitor 6 and the third embodiment can also be applied to the interdigital capacitor 6W according to the above-mentioned second embodiment.

As mentioned above, in accordance with the third embodiment, a resist film 7 constructed of an insulator is coated on the interdigital capacitor 6. Accordingly, the third embodiment offers an advantage of being able to prevent adjacent electrodes of the interdigital capacitor 6 form being short-circuited because of solder or the like, thereby blocking the flow of DC components.

Embodiment 4.

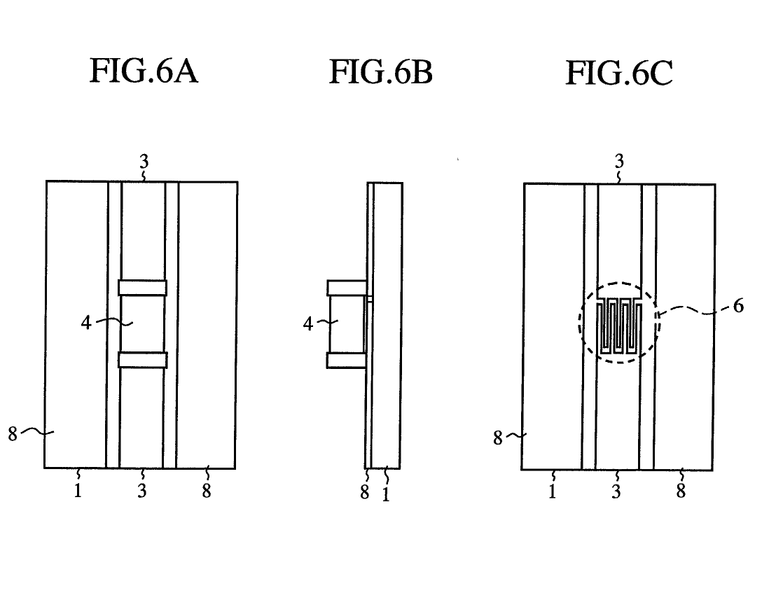

FIGS. 6A to 6C are diagrams showing the structure of a DC block circuit according to a fourth embodiment of the present invention, and FIGS. 6A and 6B are top plan views of the DC block circuit and FIG. 6C is a side view of the DC block circuit. The same reference numerals as shown in FIG. 1 denote the same components as those of the first embodiment or like components. In FIGS. 6A to 6C, reference numeral 8 denotes a ground conductor disposed on one surface of a dielectric substrate 1. The DC block circuit of FIGS. 6A to 6C constitutes a coplanar line.

The DC block circuit of the present invention is not limited to the one according to the first embodiment, and even the fourth embodiment in which a coplanar line is constructed in the DC block circuit, as shown in FIGS. 6A to 6C, offers the same advantages as provided by the first embodiment

As mentioned above, in accordance with the fourth embodiment, the DC block circuit includes a ground conductor 8 disposed on one surface of a dielectric substrate 1, and constitutes a coplanar line. Accordingly, the fourth embodiment offers an advantage of being able to provide an excellent reflection property and a good transmission loss characteristic over a wide frequency band.

Embodiment 5.

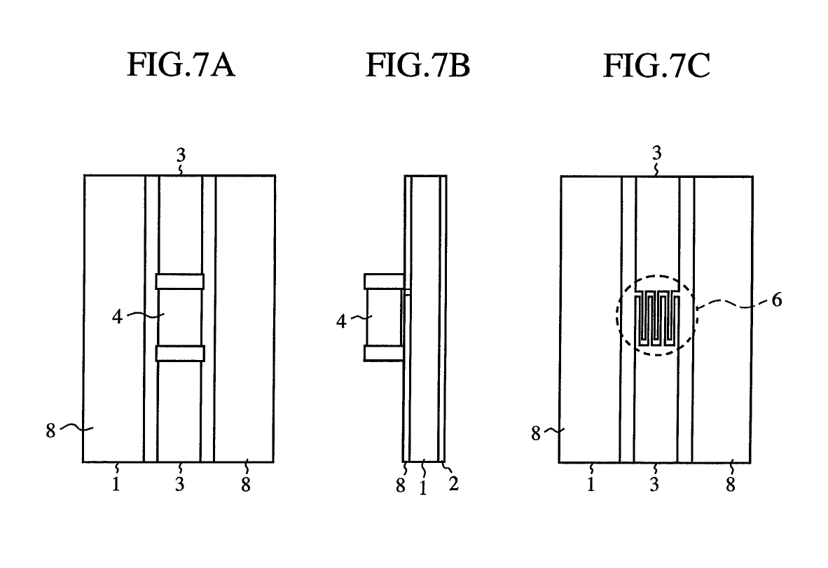

FIGS. 7A to 7C are diagrams showing an example of the structure of a DC block circuit according to a fifth embodiment of the present invention, and FIGS. 7A and 7B are top plan views of the DC block circuit and FIG. 7C is a side view of the DC block circuit. The same reference numerals as shown in FIGS. 1A to 1C and 6A to 6C denote the same components as those of the first and fourth embodiments or like components. The DC block circuit of FIGS. 7A to 7C constitutes a grounded coplanar line.

The DC block circuit of the present invention is not limited to the one according to the first embodiment or the fourth embodiment. As shown in FIGS. 7A to 7C, even the fifth embodiment in which a grounded coplanar line including the ground conductors 2 and 8 formed on two surfaces of a dielectric substrate 1 is constructed in the DC block circuit offers the same advantages as provided by the first embodiment.

As mentioned above, in accordance with the fifth embodiment, the DC block circuit includes a grounded coplanar line including ground conductors 2 and 8 formed on two surfaces of a dielectric substrate 1. Accordingly, the fifth embodiment offers an advantage of being able to provide an excellent reflection property and a good transmission loss characteristic over a wide frequency band.

Many widely different embodiments of the present invention may be constructed without departing from the spirit and scope of the present invention. It should be understood that the present invention is not limited to the specific embodiments described in the specification, except as defined in the appended claims.

What is claimed is:

1. A DC block circuit comprising:
a conductive line disposed on one surface of a dielectric substrate;
an interdigital capacitor forming apart of said conductive line; and
a chip capacitor that is disposed so that said interdigital capacitor is sandwiched between said chip capacitor and said dielectric substrate.

2. The DC block circuit according to claim 1, further comprising connectors on both ends of said conductive line.

3. The DC block circuit according to claim 1, wherein said conductive line, said interdigital capacitor, and said chip capacitor have substantially equal widths.

4. The DC block circuit according to claim 1, wherein said chip capacitor has a width greater than that of said conductive line.

5. The DC block circuit according to claim 1, wherein said interdigital capacitor has a width greater than that of said conductive line.

6. The DC block circuit according to claim 1, wherein said interdigital capacitor is coated with a resist film constructed of an insulator.

7. The DC block circuit according to claim 1, wherein a microstripline including a ground conductor formed on another surface of said dielectric substrate is constructed.

8. The DC block circuit according to claim 1, wherein a coplanar line including a ground conductor formed on the surface of said dielectric substrate is constructed.

9. The DC block circuit according to claim 1, wherein a grounded coplanar line including two ground conductors respectively formed on the surface and another surface of said dielectric substrate is constructed.

10. Communication equipment comprising:
a DC block circuit including a conductive line disposed on one surface of a dielectric substrate, an interdigital capacitor forming a part of said conductive line, and a chip capacitor that is disposed so that said interdigital capacitor is sandwiched between said chip capacitor and said dielectric substrate;
a first electric circuit connected to an end of said DC block circuit; and
a second electric circuit connected to another end of said DC block circuit, said second electric circuit having a bias supply voltage different from that of said first electric circuit.

11. The communication equipment according to claim 10, wherein said DC block circuit further includes connectors on both ends of said conductive line.

12. The communication equipment according to claim 10, wherein said conductive line, said interdigital capacitor, and said chip capacitor have substantially equal widths.

13. The communication equipment according to claim 10, wherein said chip capacitor has a width greater than that of said conductive line.

14. The communication equipment according to claim 10, wherein said interdigital capacitor has a width greater than that of said conductive line.

15. The communication equipment according to claim 10, wherein said interdigital capacitor is coated with a resist film constructed of an insulator.

16. The communication equipment according to claim 10, wherein a microstripline including a ground conductor formed on another surface of said dielectric substrate is constructed.

17. The communication equipment according to claim 10, wherein a coplanar line including a ground conductor formed on the surface of said dielectric substrate is constructed.

18. The communication equipment according to claim 10, wherein a grounded coplanar line including two ground conductors respectively formed on the surface and another surface of said dielectric substrate is constructed.

19. The communication equipment according to claim 10, comprising a multiplexing circuit, as said first electric circuit, that outputs an electrical signal to said DC block circuit, and an EA modulator, as said second electric circuit, that generates an intensity-modulated optical signal from a continuous wave optical signal according to the electrical signal applied thereto by way of said DC block circuit.

20. The communication equipment according to claim 10, comprising a photo diode with a preamplifier, as said first electric circuit, for converting an intensity-modulated optical signal applied thereto into an amplitude-modulated electrical signal, and a demultiplexer, as said second electric circuit, for demultiplexing the amplitude-modulated electrical signal.
